(19) United States
(12) Patent Application Publication
(10) Pub. No.: US 2005/0005138 A1
(43) Pub. Date: Jan. 6, 2005

(54) Data service apparatus

(76) Inventor: Shoichi Awai, Kanagawa (JP)

Correspondence Address: JAY H. MAIOLI;Cooper & Dunham LLP, 1185 Avenue of the Americas, New York, NY, 10036, US

(21) Appl. No.: 10/800,561

(22) Filed: Mar. 15, 2004

(30) Foreign Application Priority Data
Apr. 3, 2003 (JP) P2003-099835

(51) Int. Cl. G06F 7/00

(52) U.S. Cl. 713/189

(57) ABSTRACT

A data service apparatus includes a storage unit that stores digital data as a file, an encryption circuit that encrypts the digital data into an encrypted data, and a decryption circuit that decrypts the encrypted data into the initial digital data. For backing up, a file stored in the storage unit is encrypted by the encryption circuit into an encrypted test data file before being stored into an external storage unit. For decryption, the encrypted data file is extracted from the external storage unit, decrypted by the decryption circuit into the initial digital data file and written back into the storage unit. Thus, the data service apparatus can back up the stored file in the external storage unit safely and easily.

### BACKGROUND OF THE INVENTION

1. Field of the Invention

The present invention relates to a data service apparatus designed to back up various digital data in an external storage unit.

This application claims the priority of the Japanese Patent Application No. 2003-099835 filed on Apr. 3, 2003, the entirety of which is incorporated by reference herein.

2. Description of the Related Art

As the digital processing and network techniques progress, there have been proposed techniques of distributing video and audio data to the users via broadcasting and network. Also, an AV (audio and visual) apparatus, also called “AV server”, has been proposed which send distributed video and audio data for storage in an HDD (hard disk drive) or the like once and take them out of the HDD for supply to the user whenever necessary (cf. the Japanese Published Unexamined Patent Application No. 2003-30018).

However, the management of such stored data is a problem in the above-mentioned AV unit. That is, data having been copied by the user from his or her own medium such as DVD to the AV unit can easily be restored by recopying it from the DVD even if it has been destroyed due to any incorrect operation of the AV unit such as an accidental erasure or the like. However, copying all data from an original medium will take a long time and much trouble.

Also, to obtain data purchased via a network, for example, having been destroyed as above, the same money as for the lost data has to be paid again for the redistribution.

Backing up data in an AV unit by storing it in an external storage unit can prevent the above-mentioned trouble. Namely, the data stored in the AV unit, even if destroyed, can be restored from the external storage unit.

In this case, however, it is necessary to always manage the backup storage. Namely, it should always be monitored which data has been backed up, in which the data has been backed up and which data has not yet been backed up. Also, the backup system should be designed such that any falsified or destroyed data having been backed up in the external storage unit should not be restorable. Such data will possibly cause the AV unit to malfunction when restored to the AV unit from the external storage unit.

Further, only a primary AV unit should be able to restore data having been backed up in the external storage unit. If the backed-up data can be restored or copied to any AV unit other than the primary one, connected to the external storage unit, there will take place a problem that such data will possibly be copied illegally.

### OBJECT AND SUMMARY OF THE INVENTION

It is therefore an object of the present invention to overcome the above-mentioned drawbacks of the related art by providing a data service apparatus capable of backing up various digital data in an external storage unit.

The above object can be attained by providing a data service apparatus including, according to the present invention, storage means for storing digital data; an encryption circuit that encrypts digital data into encrypted data; and a decryption circuit that decrypts encrypted data into its initial digital data, and wherein digital data, to be backed up, of digital data stored in the storage means is extracted, encrypted by the encryption circuit into encrypted data and stored in an external storage unit; and encrypted data, to be decrypted, of the encrypted data stored in the external storage unit is extracted, decrypted by the decryption circuit into the initial digital data and written back to the storage means.

In the above data service apparatus, the digital data stored in the storage means is backed up in an encrypted state in the external storage unit.

According to the present invention, even if an original file stored in the data service apparatus is destroyed or damaged, it can easily be restored. Even if a file purchased via a network, for example, is broken, it can easily be restored without having to purchase the file again. Also, the medium may not be managed per file or content, which makes it easier to back up an original file.

Further, since an original file is encrypted before being backed up, its content can be protected even if the file is illegally copied by any other person. Also, it is possible to prevent the analysis of the system structure of the data service apparatus and data structure in the data service apparatus. More over, since an original file is encrypted before supplied to an external storage unit, the latter may be an ordinary one.

Also, if a file backed up in the external storage unit has been falsified before backed up, the file will not be restored to the data service apparatus which will thus be assured to operate stably. Further, since an identification code unique to the data service apparatus itself is encrypted and decrypted, it is possible to prevent illegal copying of the file via the external storage unit. Furthermore, since only an updated file is automatically backed up, the backup operation takes a reduced time.

Further, since a plurality of files to be backed up is aggregated into one file once, it is possible to avoid any discrete backup of small-size files, which leads to a more efficient data processing which will come next. Also, since a file to be stored into the external storage unit is subdivided to have an optimum file size for storage into the external storage unit, the latter is available more efficiently.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 is a schematic block diagram as one embodiment of the present invention; and

FIG. 2 is also a schematic block diagram as another embodiment of the present invention.

### DETAILED DESCRIPTION OF THE PREFERRED EMBODIMENTS

### (1) System Construction and Operation

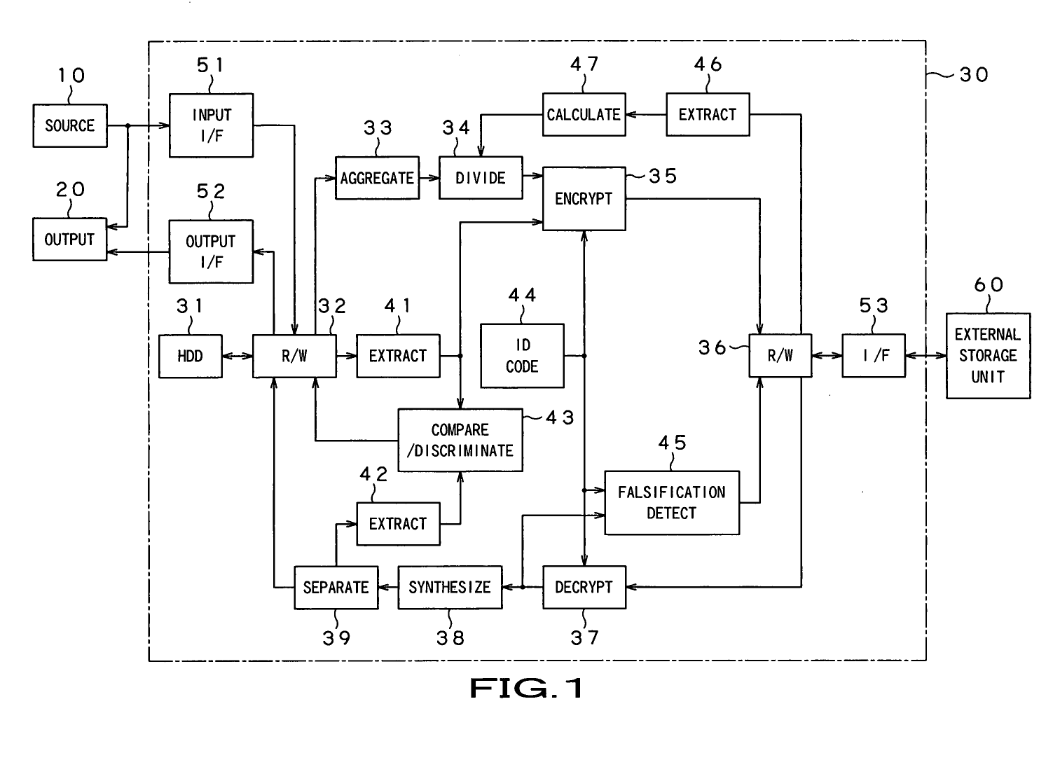

Referring now to FIG. 1, there is schematically illustrated in the form of a block diagram an AV (audio and visual) server as one embodiment of the present invention. The AV server is generally indicated with a reference 30. In FIG. 1, the reference 10 indicates one of various sources of audio and video signals, 20 indicates an output unit for image and sound, and the reference 60 indicates an external storage unit.

In this embodiment, the source 10 is a DVD player, TV broadcast tuner, CD (compact disk) player or the like. It supplies the AV server 30 with digital data such as video and audio signals. The output unit 20 includes a display and speaker (not shown). Supplied with digital data from the source 10 or AV server 30, the output unit 20 outputs the digital data as an image or sound.

The AV server 30 is provided to store digital data supplied from the source 10 as a file, which will be described in detail later. It includes, as a large-capacity storage means, an HDD (hard disk drive) 31 having a capacity of 80 GB (gigabytes) for example. The external storage unit 60 is provided to back up the digital data stored in the AV server 30. It is a commercially available, USB-connected type external HDD, for example (the “USB” stands for “universal serial bus”).

When the AV server 30 stores digital data supplied from the source 10, the digital data is supplied to a write/read circuit 32 via an input interface circuit 51 and written to the HDD 31. Note that the write/read of the digital data is similar to data write in an ordinary personal computer. Therefore, a series of digital data is written as a file to the HDD 31 in which data are be managed in files.

Also, when a file (of digital data) stored in the AV server 30 is to be used, an object or desired file is read by the write/read circuit 32 from the HDD 31 and the digital data in the file thus read is supplied to the output unit 20 via an output interface circuit 52 or reproduced as an image or sound.

### (2) Construction and Operation of the AV Server 30 (I)

The AV server 30 stores the digital data supplied from the source 10 as above into the HDD 31 and supplies it from the HDD 31 to the output unit 20. To back up the digital data stored in the HDD 31 in the external storage unit 60 and restore the backed-up digital data from the external storage unit 60, the AV server 30 is constructed and functions as will be described below.

(2-1) Overview of the Backup and Restoration

For backup of a file (of digital data) in the HDD 31, the write/read circuit 32 sequentially read a file from the HDD 31. The file thus read is supplied to the aggregation circuit 33. Even a plurality of files supplied to the aggregation circuit 33 will be aggregated into a succession of files.

When the succession of files from the aggregation circuit 33 is supplied to the division circuit 34 for storage into the external storage unit 60, it is divided by the division circuit 34 into a plurality of files each having an optimum size for that storage. The file as a result of the division is supplied to an encryption circuit 35 in which it will be encrypted into an encrypted text file. The encrypted text file is supplied via the write/read circuit 36 and an input/output interface circuit 53 to the external storage unit 60 in which it will be stored. It should be noted that in the external storage unit 60, data is stored in a form similar to the data storage form in an HDD used in a personal computer or the like. Namely, one encrypted text file is stored as one file.

Thus, the file in the HDD 31 will be backed up in the external storage unit 60.

On the contrary, to restore a file backed up in the external storage unit 60 to the HDD 31, encrypted text file are sequentially read from the external storage unit 60, and supplied via the input/output interface circuit 53 and then via the write/read circuit 36 to a decryption circuit 37 in which they will be decrypted into the initial digital data files.

Then, the files are supplied to a synthesis circuit 38 in which they will be combined together into one file similar to that supplied from the aggregation circuit 33, the file thus synthesized is supplied to a separation circuit 39 in which it will be separated into the initial files, and these files are written back to the HDD 31 via the write/read circuit 32.

Thus, the file backed up in the external storage unit 60 will be restored to the HDD 31.

(2-2) Detailed Description of the Backup and Restoration

For appropriate data backup and restoration, the AV server 30 is constructed as will be described below. That is, an extraction circuit 41 is connected to the write/read circuit 32. For the backup, data indicative of the attribute of each of files in the HDD 31, such as data indicating a file name, file size, date of storage, etc., are extracted by the extraction circuit 41 and supplied to a comparison circuit 43. The external storage unit 60 has stored therein also attribute data on files backed up therein (files having been stored in the HDD 31) as will be described in detail later. There is another extraction circuit 42 connected to the separation circuit 39. It extracts the attribute data on files backed up in the external storage unit 60 (initial files having been stored in the HDD 31 and supplied to the external storage unit 60 for the backup purpose). The attribute data thus extracted is supplied to the comparison circuit 43.

In the comparison circuit 43, the file attribute data supplied from the extraction circuits 41 and 42 are compared with each other to discriminate ones of the files backed up in the external storage unit 60 and which have been updated after the previous backup (files in the HDD 31). The discrimination result is supplied to the write/read circuit 32 in which only the files having been updated after the previous backup will be read from the HDD 31 and backed up in the external storage unit 60 as above. Also at this time, attribute data stored in the external storage unit 60 is updated correspondingly to the contents backed in the external storage unit 60.

Therefore, a file stored in the HDD 31 is backed up in the external storage unit 60, but a file stored in the HDD 31 having not been updated after the previous backup will not be backed up in the external storage unit 60 again. That is, only ones, updated (including newly stored ones), of files in the HDD 31 will be newly backed up.

Further, the AV server 30 includes an extraction circuit 46 connected to another write/read circuit 36. Data indicative of write/read characteristics of the external storage unit 60, for example, data indicating a cluster size and track size, are extracted by the extraction circuit 46 and supplied to a file size calculation circuit 47 that will calculate an optimum size for write/read of data to/from the external storage unit 60 and supply data indicative of the optimum size to the division circuit 34.

Thus in the backup operation, the division circuit 34 divides the file from the aggregation circuit 35 into a plurality of files each having an optimum size for storage into the external storage unit 60 as above according to the optimum size calculated by the file size calculation circuit 47.

The AV server 30 further includes an identification code generation circuit 44 that extracts an identification code unique to the AV server 30 itself, for example, a MAC (media access control) address, or a unique identification code the user assigns to every AV server 30, and supplies it to the encryption circuit 35 as encryption key data. Thus, during the backup operation, the encryption circuit 35 encrypts the files supplied from the division circuit 34 into a file of encrypted data according to the identification code supplied from the identification code generation circuit 44.

For the restoration, the identification code generation circuit 44 supplies an identification code to the decryption circuit 37 which will decrypt a file of encrypted data extracted from the external storage unit 60 and supplied to the decryption circuit 37 into a file of the initial digital data according to the supplied identification code.

During the above decryption, however, the decrypted file and the identification code from the identification code generation circuit 44 are supplied to a falsification detection circuit 45 that checks whether the file extracted from the external storage unit 60 is a falsified one. If the file is found falsified, the falsification detection circuit 45 provides an output of falsification detection under which the write/read circuit 36 will be controlled to cease acquisition of the encrypted data from the external storage unit 60. In other words, write of a decrypted file to the HDD 31 will be inhibited.

On the contrary, when the file extracted from the external storage unit 60 is found not falsified, the file decrypted by the decryption circuit 37 as above will be supplied to the separation circuit 39 in which it will be separated into initial files and then written back to the HDD 31.

Thus, the AV server 30 shown in FIG. 1 backs up a file in the HDD 31 into the external storage unit 60. So, even if any file in the HDD 31 is destroyed or damaged, it can easily be restored. For example, even if a file having been purchased via a network for example, it can easily be restored without having to re-purchase the file. Also, since all files in the HDD 31 are backed up in one external storage unit 60, no backup medium may be managed per file or content, which also contributes to the easy backup.

Further, since a file in the HDD 31 is encrypted before being backed up in the external storage unit 60, its content can be protected even if any other person copies any file in the external storage unit 60 to a personal computer or the like. Also, it is possible to prevent the analysis of the system structure of the AV server 30 and data structure in the AV server 30. More over, since a file in the HDD 31 is encrypted before supplied, for backup, to the external storage unit 60, the latter may be an ordinary one.

Also, if a file backed in the external storage unit 60 has been falsified, it will not be restored to the AV server 30. Thus, it is possible to assure a stable operation of the AV server 30.

Also, even if it is tried to back up a file in a first AV server 30 into a second AV server 30 and then restore the file in the first AV server 30 to the second server 30 by connecting the first AV server 30 to the second AV server 30, restoration of the file from the external storage unit 60 to the second AV server 30 will not be accepted since the file is encrypted and decrypted according an identification code unique to each AV server 30. Therefore, even if another AV server is used which is identical in construction to the AV server 30, any file can be prevented from being illegally copied from the external storage unit 60 to such an AV server.

Also, since the comparison/discrimination circuit 43 compares a file in the HDD 31 and a file in the external storage unit 60 concerning their attribute data and thus only files having been updated are backed up, the file backup can be done in a reduced time.

Further, since a plurality of files in the HDD 31, to be backed up, is aggregated into one file once, it is possible to avoid any discrete backup of small-size files, which leads to a more efficient data processing to be done subsequently to the backup. Also, since a file to be stored into the external storage unit 60 is subdivided to have an optimum file size for storage into the external storage unit 60, the latter is available more efficiently.

### (3) Construction and Operation of the AV Server 30 (II)

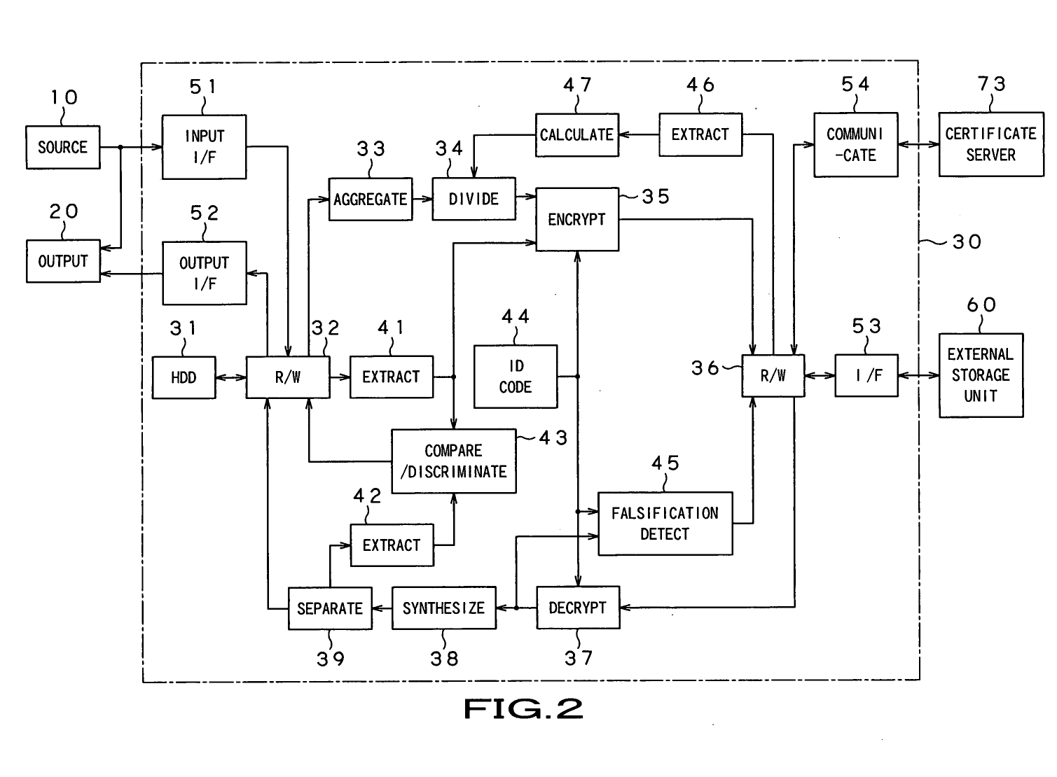

Referring now to FIG. 2, there is schematically illustrated in the form of a block diagram another embodiment of the data service apparatus of the present invention. As in FIG. 2, this AV server is also generally indicated with the reference 30, and it is used with the external storage unit 60 and a certificate server 70 as well. As will be seen in FIG. 2, the AV server 30 includes a communications circuit 54 in addition to the components of the AV server 30 in FIG. 1. When restoring data backed in the external storage unit 60 to the HDD 31, information resulted from synthetic combination of information on data to be restored and identification code for the AV server 30 is sent to the certificate server 70 via the communications circuit 54. It should be noted that the communications circuit 54 can be connected to the certificate server 70 via a network such as Internet or the like and communications with the certificate server 70 can be done through encryption.

As a result, only when a permission of restoration is received from the certificate server 70, a file backed up in the external storage unit 60 is restored to the HDD 31. Also, if the certificate server 70 issues no permission of restoration, the AV server 30 will alarm by a display. Therefore, this AV server 30 can prevent the file backed up in the external storage unit 60 from being copied illegally.

Also, since the communications between the communications circuit 54 and certificate server 70 are encrypted and even data illegally intercepted and decrypted has a value depending upon data to be restored, it is not possible to extract the identification code for the AV server 30 alone and thus any user information in the AV server 30 will not leak out.

### (4) Miscellaneous

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

For example, although the source 10 used with the AV server according to the present invention is to supply video and audio signals as having previously been described, it may be a signal source of a personal computer, network or the like that supplies digital data such as electronic mail, text data, still or moving picture data or the like.

Also, the AV server may be designed to alarm, by a display, when the total size of files stored in the HDD 31 and going to be backed up in the external storage unit 60 is larger than the remaining capacity of the external storage unit 60.

1. A data service apparatus comprising:
storage means for storing digital data;
an encryption circuit for encrypting digital data into encrypted data;
a decryption circuit for decrypting encrypted data into its initial digital data, and wherein
digital data, to be backed up, stored in the storage means is extracted, encrypted by the encryption circuit into encrypted data and stored in an external storage unit; and
encrypted data, to be decrypted, stored in the external storage unit is extracted, decrypted by the decryption circuit into the initial digital data and written back to the storage means.

2. The data service apparatus according to claim 1, further comprising an identification code generation circuit for generating an identification code unique to the data service apparatus, wherein
the encryption circuit performs the encryption according to the identification code generated by the identification code generation circuit; and
the decryption circuit performs the decryption according to the identification code generated by the identification code generation circuit.

3. The data service apparatus according to claim 2, further comprising a falsification detection circuit for checking, when decrypting the digital data from the encrypted data, the digital data according to the identification code generated by the identification code generation circuit, and for inhibiting the initial digital data from being written back to the storage means when it is found that the digital data has been falsified.

4. The data service apparatus according to any one of claims 1, 2 and 3, further comprising a comparison circuit for making a comparison in attribute data between the digital data in the storage means and the digital data stored in the external storage unit, wherein
digital data, updated after previously backed up in the external storage unit, stored in the storage means is stored into the external storage unit according to a comparison result from the comparison circuit.

5. The data service apparatus according to claim 4, further comprising:
a detection circuit for detecting an optimum file of digital data for storage as a file into the external storage unit;
an aggregation circuit for aggregating a plurality of files into one file;
a division circuit for dividing a file into a plurality of files each having a predetermined size;
a synthesis circuit for combining the divided files together into one file; and
a separation circuit for separating one file formed from a plurality of files into the plurality of files, wherein
for backup of the digital data:
digital data read by the aggregation circuit from the storage means are aggregated into one file;
the file as a result of the aggregation is divided by the division circuit according to the size detected by the detection circuit; and
the file as a result of the division being stored into the external storage unit; and wherein
for decryption of the digital data:
the encrypted data stored in the external storage unit are decrypted and combined by the synthesis circuit into an initial one file; and
the file as a result of the synthetic combination is separated by the separation circuit into the plurality of initial digital data and written back to the storage means.

6. The apparatus according to claim 5, further comprising a communications circuit for performing information communications with an external certificate server, wherein
an inquiry is made about whether the digital data to be decrypted may be restored to the external certificate server via the communications circuit, and the restoration is done only when the communications circuit has received a permission of restoration from the external certificate circuit.
